(19) United States
(12) Patent Application Publication
(10) Pub. No.: US 2026/0347580 A1
(43) Pub. Date: Nov. 5, 2026

(54) POLYETHYLENE COMPOSITIONS FOR BLOW MOLDING, COMPRISING WASTE RECOVERED POLYETHYLENE

(71) Applicant: Basell Polyolefine GmbH, Wesseling (DE)

(72) Inventors: Harald Schmitz, Frankfurt (DE); Helmut Gersema, Frankfurt (DE); Peter Bisson, Frankfurt (DE)

(73) Assignee: Basell Polyolefine GmbH, Wesseling (DE)

(21) Appl. No.: 19/112,547

(22) PCT Filed: Sep. 18, 2023
(86) PCT No.: PCT/EP2023/075571

§ 371 Date: Mar. 17, 2025

(30) Foreign Application Priority Data
Sep. 20, 2022 (EP) 22196520.5

(51) Int. Cl. C08L 23/0807

(52) U.S. Cl. CPC C08L 23/0815; C08L 2205/025; C08L 2205/03; C08L 2207/20

(57) ABSTRACT

A polyethylene composition for blow molding made from or containing:
I) from 25% to 85% by weight of waste recovered polyethylene; and
II) from 15% to 75% by weight of polyethylene, having an at least trimodal molecular weight distribution.

### FIELD OF THE INVENTION

In general, the present disclosure relates to the field of chemistry. More specifically, the present disclosure relates to polymer chemistry. In particular, the present disclosure relates to polyethylene compositions made from or containing waste recovered polyethylene.

### BACKGROUND OF THE INVENTION

Polyolefins are consumed for applications, including packaging for food and other goods, automotive components, fibers, and manufactured articles. The quantity of polyolefins raises concerns for the environmental impact of the waste materials generated after the first use of the polyolefins.

Waste plastic materials are coming from differential recovery of municipal plastic waste, also called post-consumer waste (PCW). In some instances, municipal plastic waste includes flexible packaging (cast films, blown films, and bioriented films), rigid packaging, blow molded containers, and injection molded containers. In some instances, through a step of separation from other polymers, polyolefinic fractions are obtained. In some instances, the other polymers are PVC, PET, or PS. In some instances, the polyolefinic fractions include ethylene polymers and propylene polymers. In some instances, the ethylene polymers are HDPE, LDPE, or LLDPE. In some instances, the propylene polymers are homopolymers, random copolymers, or heterophasic copolymers.

In some instances, the multicomponent nature of the recovered material results in low mechanical properties.

In some instances and to mitigate the degradation of mechanical properties, the recovered material is blended with virgin polymer.

In some instances, the polymer blends involve the preparation of virgin HDPE by sequential polymerization in a cascade of reactors.

In some instance, waste recovered polyethylene has poor impact strength, lacks sufficient environmental stress cracking resistance (ESCR), and faces processing challenges.

In some instances, the presence of propylene polymers as contaminants decreases the weld strength of the welding lines in blow molded articles.

In some instances, the waste recovered polyethylene fails to achieve swell ratio values for controlled, uniform wall thickness in blow-molding applications.

### SUMMARY OF THE INVENTION

In a general embodiment, the present disclosure provides a polyethylene composition made from or containing:
I) from 25% to 85% by weight, alternatively from 40% to 60% by weight, of waste recovered polyethylene; and
II) from 15% to 75% by weight, alternatively from 40% to 60% by weight, of polyethylene, having an at least trimodal molecular weight distribution and
   1) a density from 0.950 to 0.960 g/cm³, alternatively from 0.950 to 0.958 g/cm³, determined according to ISO 1183-1:2012 at 23 °C;
   2) an MIF from 6 to 12 g/10 min., alternatively from 8 to 12 g/10 min., where MIF is the melt flow index at 190 °C with a load of 21.60 kg, determined according to ISO 1133-1 2012-03;
   3) an MIP from 0.20 to 1.0 g/10 min., alternatively from 0.30 to 0.80 g/10 min., alternatively from 0.35 to 0.80 g/10 min., where MIP is the melt flow index at 190 °C with a load of 5 kg, determined according to ISO 1133-1 2012-03; and
   4) a ratio MIF/MIP of from 12 to 30, alternatively from 15 to 30, alternatively from 15 to 25;
wherein the amounts by weight of components I) and II) are referred to the total weight of the sum of I) and II).

In some embodiments, the present disclosure provides articles of manufacture made from or containing polyethylene composition.

### DETAILED DESCRIPTION OF THE INVENTION

In some embodiments, the polyethylene composition has a density from 0.945 to 0.962 g/cm³, alternatively from 0.950 to 0.960 g/cm³.

In some embodiments, the MIF of the polyethylene composition is from 5 to 30 g/10 min., alternatively from 10 to 25 g/10 min.

In some embodiments, the MIP of the polyethylene composition is from 0.3 to 5 g/10 min., alternatively from 0.5 to 3 g/10 min., alternatively from 0.5 to 1 g/10 min.

In some embodiments, the MIE of the polyethylene composition is from 0.05 to 5 g/10 min., alternatively from 0.1 to 1 g/10 min., alternatively from 0.1 to 0.5 g/10 min, where MIE is the melt flow index at 190 °C with a load of 2.16 kg, determined according to ISO 1133-1 2012-03.

In some embodiments, the waste recovered polyethylene (I) is a polyethylene recovered from plastic waste.

In some embodiments, the recovery process consists of a waste treatment, including the steps of collection, shredding, sorting and washing.

In some embodiments, the waste recovered polyethylene (I) contains minor amounts of other polymeric, inorganic components, or both. In some embodiments, the waste recovered polyethylene (I) contains propylene polymers in an amount from 1% to 15% by weight, alternatively from 3% to 10% by weight, with respect to the total weight of the waste recovered polyethylene.

In some embodiments, the waste recovered polyethylene (I) is a PCW, that is, a post-consumer waste. In some embodiments, the waste recovered polyethylene (I) is made from or containing pre-consumer waste (Pre-CW). In some embodiments, PCW is a waste material deriving from at least one use cycle. In some embodiments, Pre-CW is a plastic waste diverted from a manufacturing process which is not reutilized and is not reincorporated in the same process that generated the plastic waste. In some embodiments, Pre-CW is rework, regrind or scrap.

In some embodiments, the waste recovered polyethylene (I) is a material deriving from an article manufacturing process.

In some embodiments, the waste recovered polyethylene (I) is a high density polyethylene (HDPE).

In some embodiments, the waste recovered polyethylene (I) has a density of from 0.940 g/cm³ to 0.965 g/cm³.

In some embodiments, the MIF of the waste recovered polyethylene (I) is from 1 to 100 g/10 min., alternatively from 5 to 60 g/10 min.

In some embodiments, the MIP of the waste recovered polyethylene (I) is from 0.5 to 10 g/10 min., alternatively from 1 to 5 g/10 min.

In some embodiments, the MIE of the waste recovered polyethylene (I) is from 0.1 to 10 g/10 min., alternatively from 0.2 to 5 g/10 min., where MIE is the melt flow index at 190 °C with a load of 2.16 kg, determined according to ISO 1133-1 2012-03.

In some embodiments, the swell ratio of the waste recovered polyethylene (I) is from 130% to 190%.

In some embodiments, the stress crack resistance, measured by FNCT 6 MPa/50 °C, of the waste recovered polyethylene (I) is equal to or higher than 2 h, alternatively from 2 to 15 h.

In some embodiments, the waste recovered polyethylene (I) is commercially available.

In some embodiments, the waste recovered polyethylene (I) is commercially available under the tradename CirculenRecover HD5603 in Silver or Ivory versions from LyondellBasell Industries.

In some embodiments, the polyethylene component (II) is a virgin polyethylene.

As used herein, the expression “virgin polyethylene” refers to a polymer which has not been subjected to a process for production of finished articles or semi-finished articles. In some embodiments, finished articles are packaging films, pipes, bottles, or containers. In some embodiments, semi-finished articles are fibers or sheets for thermoforming.

In some embodiments, the virgin polyethylene has not been subjected to post-production working. For purposes of this disclosure, pelletization is considered part of the polymer production process. As such, pelletization is not a considered a post-production working.

In some embodiments, the polyethylene component (II) has at least one of the following additional features:
a MIE of 0.01 to 1 g/10 min., alternatively from 0.05 to 0.5 g/10 min.;
a stress crack resistance, measured by FNCT 6 MPa/50 °C, equal to or higher than 50 h, alternatively from 50 to 200 h;
a swell ratio from 130% to 180%; or
a Charpy aCN fracture toughness at −30 °C from 5 to 20 kJ/m².

As used herein, the expression “at least trimodal molecular weight distribution” refers to the polyethylene component (II) made from or containing at least three fractions with different molecular weights. In some embodiments, the fractions include a first (A) low molecular weight fraction, a second (B) high molecular weight fraction, and a third (C) ultra-high molecular weight fraction.

In some embodiments, the molecular weight distribution curve of the resulting final polymer, obtained by GPC (Gas Permeation Chromatography) analysis, is looked at as the superposition of the molecular weight distribution curves of the polymer fractions. In some embodiments, the molecular weight distribution curve shows three or more distinct maxima. In some embodiments, the molecular weight distribution curve shows distinctly broadened maxima compared with the individual curves for the individual fractions.

In some embodiments, the polyethylene component (II) is made from or containing from 40 to 50% by weight of a low molecular weight ethylene homopolymer A), from 25 to 40% by weight of a high molecular weight ethylene copolymer B), and from 15 to 28% by weight of an ultrahigh molecular weight ethylene copolymer C).

The weight amounts are referred to the total weight of A)+B)+C).

In some embodiments, the ethylene homopolymer A) has a MIE_{1.2} from 30 to 120 g/10 min., alternatively from 40 to 100 g/10 min., where MIE_{1.2} is the melt flow index at 190 °C with a load of 1.2 kg, determined according to ISO 1133-1 2012-03.

In some embodiments, the density of the ethylene homopolymer A) is equal to or higher than 0.962 g/cm³, alternatively equal to or higher than 0.965 g/cm³.

In some embodiments, the ethylene copolymer B) has a MIP from 2 to 15 g/10 min., alternatively from 3 to 10 g/10 min.

In some embodiments, the density of the ethylene copolymer B) is equal to or higher than 0.955 g/cm³, alternatively from 0.955 to 0.960 g/cm³.

In some embodiments, the ethylene copolymer C) has a MIF from 0.1 to 5 g/10 min., alternatively from 0.2 to 2 g/10 min.

In some embodiments, the density of the ethylene copolymer C) is equal to or higher than 0.950 g/cm³, alternatively from 0.950 to 0.954 g/cm³.

In some embodiments, the comonomer or comonomers present in the ethylene copolymers are selected from olefins having formula CH₂═CHR wherein R is an alkyl radical, linear or branched, having from 1 to 10 carbon atoms.

In some embodiments, the comonomer or comonomers are selected from the group consisting of propylene, butene-1, pentene-1, 4-methylpentene-1, hexene-1, octene-1 and decene-1. In some embodiments, the comonomer or comonomers are selected from the group consisting of butene-1 and hexene-1.

In some embodiments, the ethylene copolymer B) contains from 0.2% to 0.5% by weight of comonomer(s) with respect to the total weight of the copolymer.

In some embodiments, the ethylene copolymer C) contains from 1% to 2% by weight of comonomer(s) with respect to the total weight of the copolymer.

In some embodiments, the polyethylene component (II) is prepared by polymerization in the presence of a Ziegler-Natta catalyst.

In some embodiments, the Ziegler-Natta catalyst is made from or containing the product of the reaction of an organometallic compound of group 1, 2 or 13 of the Periodic Table of elements with a transition metal compound of groups 4 to 10 of the Periodic Table of Elements (new notation). In some embodiments, the transition metal compound is selected from the group consisting of compounds of Ti, V, Zr, Cr and Hf. In some embodiments, the transition metal compound is supported on MgCl₂.

In some embodiments, the catalysts are made from or containing the product of the reaction of the organometallic compound of group 1, 2 or 13 of the Periodic Table of elements, with a solid catalyst component made from or containing a Ti compound supported on MgCl₂.

In some embodiments, the organometallic compounds are organo-Al compounds.

In some embodiments, the polyethylene component (II) is obtainable by using a Ziegler-Natta polymerization catalyst, alternatively a Ziegler-Natta catalyst supported on MgCl₂, alternatively a Ziegler-Natta catalyst made from or containing the product of reaction of:
a) a solid catalyst component made from or containing a Ti compound and optionally an
electron donor compound ED (internal electron donor) supported on MgCl₂;
b) an organo-Al compound; and optionally
c) an external electron donor compound EDₑₓₜ.

In some embodiments and in component a), the ED/Ti molar ratio ranges from 1.5 to 3.5 and the Mg/Ti molar ratio is higher than 5.5, alternatively from 6 to 80.

In some embodiments, the titanium compounds are the tetrahalides or the compounds of formula TiXₙ(OR¹)₄₋ₙ, where 0≤n≤3, X is halogen, and R¹ is C₁-C₁₀ hydrocarbon group. In some embodiments, the halogen is chlorine.

In some embodiments, the titanium compound is titanium tetrachloride.

In some embodiments, the optional ED compound is selected from the group consisting of alcohol, ketones, amines, amides, nitriles, alkoxysilanes, aliphatic ethers, and esters of aliphatic carboxylic acids.

In some embodiments, the ED compound is an ester. In some embodiments, the esters are alkyl esters of C1-C20 aliphatic carboxylic acids, alternatively C1-C8 alkyl esters of aliphatic mono carboxylic acids. In some embodiments, the esters are selected from the group consisting of ethylacetate, methyl formiate, ethylformiate, methylacetate, propylacetate, i-propylacetate, n-butylacetate, and i-butylacetate. In some embodiments, the ethers are aliphatic ethers, alternatively C2-C20 aliphatic ethers. In some embodiments, the ether is tetrahydrofuran (THF) or dioxane.

In some embodiments, the external electron donor compound EDₑₓₜ is the same as or different from the ED used in the solid catalyst component a). In some embodiments, the external electron donor compound EDₑₓₜ is selected from the group consisting of ethers, esters, amines, ketones, nitriles, silanes, and their mixtures. In some embodiments, the external electron donor compound EDₑₓₜ selected from C2-C20 aliphatic ethers, alternatively cyclic ethers. In some embodiments, the cyclic ethers have 3-5 carbon atoms. In some embodiments, the ethers are selected from the group consisting of tetrahydrofuran and dioxane.

In some embodiments, the polymerization is continuous or batch. In some embodiments, the polymerization is carried out in liquid phase, in gas phase, or by mixed liquid-gas techniques. In some embodiments, the liquid phase process is in the presence of inert diluent. In some embodiments, the liquid phase process is not in the presence of inert diluent.

In some embodiments and for preparing the ethylene polymer fractions A), B) and C), the polymerization process is carried out in three or more reactors connected in series, wherein the fractions are prepared in separate subsequent stages, operating in each stage, except for the first stage, in the presence of the polymer formed and the catalyst used in the preceding stage.

In some embodiments, the catalyst is added in the first reactor and not a subsequent reactor. In some embodiments, the catalyst is added in more than one reactor.

In some embodiments, the reaction time, pressure and temperature vary. In some embodiments, the reaction temperature is from 50 to 100 °C. In some embodiments, the reaction pressure is atmospheric or higher, alternatively in the range of from 0.15 to 1 MPa.

In some embodiments, the regulation of the molecular weight is carried out by regulators. In some embodiments, the molecular weight regulator is hydrogen.

In some embodiments, the polymerization process is as described in Patent Cooperation Treaty Publication No. WO2004058876.

In some embodiments, the ethylene polymer fractions A), B) and C) are prepared separately, in a single reactor under the above described conditions, followed by mechanical blending of the fractions together.

In some embodiments, the polyethylene composition is further made from or containing additives. In some embodiments, the additives are selected from the group consisting of heat stabilizers, antioxidants, UV absorbers, light stabilizers, metal deactivators, compounds which destroy peroxide, and basic co-stabilizers. In some embodiments, the additives are present in amounts of from 0.05% to 10% by weight, alternatively from 0.05% to 5% by weight, based on the total weight of the polyethylene composition.

In some embodiments, the polyethylene composition is further made from or containing additional components selected from the group consisting of fillers, reinforcing agents, plasticizers, lubricants, emulsifiers, pigments, optical brighteners, flame retardants, antistatic agents, blowing agents, and combinations thereof. In some embodiments, the additional components are present in total amounts of from 1 to 50% by weight, based on the total weight of the polyethylene composition.

In some embodiments, the polyethylene composition is obtainable by melting and mixing the components. In some embodiments, the mixing is effected in a mixing apparatus at temperatures from 160 to 250 °C.

In some embodiments, the melt-mixing apparatuses are extruders or kneaders, alternatively twin-screw extruders. In some embodiments, the components are premixed at room temperature in a mixing apparatus.

In some embodiments, the polyethylene composition is for producing blow molded articles. In some embodiments, the present disclosure provides blow-molded articles made from or containing the polyethylene composition.

In some embodiments, the blow-molded articles are small.

In some embodiments, the small blow-molded articles have a capacity from 250 to 5000 ml. In some embodiments, the small blow-molded articles are selected from the group consisting of containers, canisters and bottles.

In some embodiments, the polyethylene composition has an environmental stress crack resistance, measured by FNCT 6 MPa/50 °C, equal to or higher than 15 h, alternatively equal to or higher than 18 h, alternatively from 15 to 50 h or from 18 to 50 h.

In some embodiments, the swell ratio of the polyethylene composition is from 130% to 180%.

In some embodiments, the Charpy aCN fracture toughness at −30 °C of the polyethylene composition is from 3 to 10 kJ/m².

In some embodiments, the blow-molding process is carried out by first plasticizing the polyethylene composition in an extruder at temperatures in the range from 180 to 250 °C and then extruding the polyethylene composition through a die into a blow mold, where the polyethylene composition is cooled.

### EXAMPLES

In some instances, the practice of the various embodiments, compositions and methods as provided herein are disclosed below in the following examples. These examples are illustrative and are not intended to limit the scope of the appended claims in any manner whatsoever.

The following analytical methods are used to characterize the polymer compositions.

### Melt Flow Index

Determined according to ISO 1133-1 2012-03 at 190 °C with the specified load.

### Density

Determined according to ISO 1183-1:2012 at 23 °C.

### Swell Ratio

The Swell-ratio was measured utilizing a capillary rheometer, Göttfert Rheotester2000 and Rheograph25, at T=190 °C, equipped with a 30/2/2/20 die (total length 30 mm, Active length=2 mm, diameter=2 mm, L/D=2/2 and 20° entrance angle) and an optical device (laser-diod from Göttfert) for measuring the extruded strand thickness. The sample was melted in the capillary barrel at 190 °C for 6 min and extruded with a piston velocity corresponding to a resulting shear-rate at the die of 1440 s⁻¹.

The extrudate was cut (by an automatic cutting device from Göttfert) at a distance of 150 mm from the die-exit, at the moment the piston reached a position of 96 mm from the die-inlet. The extrudate diameter was measured with the laser-diod at a distance of 78 mm from the die-exit, as a function of time. The maximum value corresponded to the D_{extrudate}. The swell-ratio was determined from the calculation:

SR=(D_{extrudate}−D_{die})100%/D_{die}

where D_{die} is the corresponding diameter at the die exit, measured with the laser-diod.

### Environmental Stress Cracking Resistance According to Full Notch Creep Test (FNCT)

The environmental stress cracking resistance of polymer samples was determined in accordance with international standard ISO 16770 (FNCT) in aqueous surfactant solution. From the polymer sample, a compression molded 10 mm thick sheet was prepared. The bars with squared cross section (10×10×100 mm) were notched, using a razor blade, on four sides perpendicularly to the stress direction. A notching device described in M. Fleissner in Kunststoffe 77 (1987), pp. 45 was used for the sharp notch with a depth of 1.6 mm.

The load applied was calculated from tensile force divided by the initial ligament area. Ligament area was the remaining area=total cross-section area of specimen minus the notch area. For FNCT specimen: 10×10 mm²−4 times of trapezoid notch area=46.24 mm² (the remaining cross-section for the failure process/crack propagation). The test specimen was loaded with standard condition suggested by the ISO 16770 with constant load of 6 MPa at 50 °C in a 2% (by weight) water solution of non-ionic surfactant ARKOPAL N100. Time until rupture of test specimen was detected.

### Charpy aCN

Fracture toughness was determined by an internal method on test bars measuring 10×10×80 mm and cut from a compression molded sheet with a thickness of 10 mm. Six of these test bars were notched in the center using a razor blade in the notching device mentioned above for FNCT. The notch depth was 1.6 mm. The measurement was carried out in accordance with the Charpy measurement method in accordance with ISO 179-1, with modified test specimens and modified impact geometry (distance between supports). The test specimens were conditioned to the measurement temperature of −30 °C over a period of from 2 to 3 hours. A test specimen was then placed without delay onto the support of a pendulum impact tester in accordance with ISO 179-1. The distance between the supports was 60 mm. The drop of the 2 J hammer was triggered, with the drop angle being set to 160°, the pendulum length to 225 mm, and the impact velocity to 2.93 m/s. The fracture toughness value was expressed in kJ/m² and given by the quotient of the impact energy consumed and the initial cross-sectional area at the notch, aCN. Values for complete fracture and hinge fracture were used (see suggestion by ISO 179-1).

### Welding Quality

22 g blow molded bottles with an internal volume of 310 ml and average wall thickness 0.8 mm were prepared with a W. Müller molding machine, model Blowtec BFB 1/4.

The machine parameters were:
Processing temperature: 200 °C;
Mold temperature: 12 °C;
Molding cycle time: 15 sec;
Blow pressure: 5 bar;
Throughput: 7 Kg/h.

A bottom weld sample was cut from the bottle, after deflashing. The bottom weld samples were then bent twice manually, and manual tear off was tried. A sample was classified as “good” if the sample did not break along the weld. A sample was classified as “bad” if the sample broke.

### Comonomer Content

The comonomer content was determined by IR in accordance with ASTM D 6248 98, using an FT-IR spectrometer Tensor 27 from Bruker, calibrated with a chemometric model for determining ethyl-side-chains in PE for butene-1 as comonomer. The result was compared to the estimated comonomer content derived from the mass-balance of the polymerization process and found to agree.

### Polypropylene Content

¹³C NMR spectra were acquired on a Bruker AV-600 spectrometer equipped with cryoprobe, operating at 160.91 MHz in the Fourier transform mode at 120 °C.

The peak of the CH₂ ethylene was used as internal standard at 29.9 ppm. The samples were dissolved in 1,1,2,2-tetrachloroethane-d2 at 120 °C with an 8% wt/v concentration. Each spectrum was acquired with a 900 pulse, 15 seconds of delay between pulses and CPD, thereby removing ¹H-¹³C coupling. 512 transients were stored in 32K data points using a spectral window of 9000 Hz.

Molar composition was obtained, according to the following, using peak areas (Table A):

P=100A₃/S

E=0.5100A₂/S

Where S=0.5A₂+A₃

Molar content was transformed in weight using monomers molecular weight.

TABLE 1
Assignment of PP/PE mixtures

| Number | Chemical Shift (ppm) | Carbon | Sequence |
|---|---|---|---|
| 1 | 48.8-45.4 | CH₂ | P |
| 2 | 29.9 | CH₂ | E |
| 3 | 29.0-28.0 | CH | P |
| 4 | 21.8-19.8 | CH3 | P |

### Example 1 and Comparative Example 1

The waste recovered polyethylene (I) was CirculenRecover® HD5603 Grey, which was commercially available from LyondellBasell Industries.

CirculenRecover® HD5603 Grey was a PCW HDPE, containing around 9% by weight of propylene polymer(s) with respect to the total weight, and having the properties reported in Table 1, wherein the PCW HDPE is identified as QCP 5603.

The polyethylene composition of Example 1 was obtained by blending 50% by weight of QCP 5603 Grey with 50% by weight of PE-1, which was a polyethylene with trimodal molecular weight distribution, having the properties reported in Table 1.

The polyethylene PE-1, representing component (II), was made from or containing 45% by weight of a low molecular weight ethylene homopolymer A) with an MI_{1.2} of 75 g/10 min. and a density of about 0.968 g/cm³, 33% by weight of a high molecular weight ethylene/butene-1 copolymer B) with an MIP of 7.5 g/10 min. and a density of 0.958 cm³, and 22% by weight of an ultrahigh molecular weight ethylene/butene-1 copolymer C) with an MIF of 0.65 g/10 min. and a density of 0.953 g/cm³.

The weight amounts are referred to the total weight of A)+B)+C).

The polyethylene PE-1 was prepared by analogy with Example 1 of Patent Cooperation Treaty Publication No. WO2004058876.

The polyethylene composition of Comparative Example 1 was obtained by blending 50% by weight of QCP 5603 Grey with 50% by weight of Hostalen® ACP 5831 D, having the properties reported in Table 1, identified as 5831 D.

Hostalen® ACP 5831 D is a polyethylene with trimodal molecular weight distribution, commercially available from LyondellBasell Industries.

The polyethylene compositions of the examples were prepared by blending the components in a twin-screw extruder Leistritz ZSE 27 MAXX 44D, operating at 250 rpm, with temperatures of 230 °C (first barrel) and 250 °C (second to 10^{th} barrel and die).

The properties of the final compositions are reported in Table 2.

TABLE 1

| | QCP 5603 | PE-1 | 5831 D |
|---|---|---|---|
| MIF [g/10 min] | 45 | 9.9 | 20 |
| MIP [g/10 min] | 2.05 | 0.45 | 0.94 |
| MIE [g/10 min] | 0.4 | 0.1 | 0.21 |
| Density [g/cm³] | 0.958 | 0.954 | 0.958 |
| Swell ratio [%] | 168 | 145 | 143 |
| FNCT (50 °C, 6 MPa) [h] | 7 | 100 | 18 |
| ACN (−30 °C) [kJ/m²] | 2.5 | 8.0 | 7 |
| Welding quality | bad | good | good |

TABLE 2

| | Example 1 | Comp Ex. 1 |
|---|---|---|
| MIF [g/10 min] | 18.7 | 28.7 |
| MIP [g/10 min] | 0.86 | 1.48 |
| MIE [g/10 min] | 0.2 | 0.3 |
| Density [g/cm³] | 0.956 | 0.958 |
| Swell ratio [%] | 148 | 157 |
| FNCT (50 °C, 6 MPa) [h] | 27 | 10 |
| ACN (−30 °C) [kJ/m²] | 4.3 | 4.1 |
| Welding quality | good | bad |

1. A polyethylene composition comprising:
I) from 25% to 85% by weight of waste recovered polyethylene; and
II) from 15% to 75% by weight of polyethylene, having an at least trimodal molecular weight distribution and
1) a density from 0.950 to 0.960 g/cm³, determined according to ISO 1183-1:2012 at 23 °C;
2) an MIF from 6 to 12 g/10 min., where MIF is the melt flow index at 190 °C with a load of 21.60 kg, determined according to ISO 1133-1 2012-03;
3) an MIP from 0.20 to 1.0 g/10 min., where MIP is the melt flow index at 190 °C with a load of 5 kg, determined according to ISO 1133-1 2012-03; and
4) a ratio MIF/MIP of from 12 to 30;
wherein the amounts by weight of components I) and II) are referred to the total weight of the sum of I) and II).

2. The polyethylene composition according to claim 1, wherein the waste recovered polyethylene (I) is a PCW.

3. The polyethylene composition according to claim 1, wherein the waste recovered polyethylene (I) has a density from 0.940 g/cm³ to 0.965 g/cm³.

4. The polyethylene composition according to claim 1, wherein the waste recovered polyethylene (I) has a swell ratio from 130% to 190%.

5. The polyethylene composition according to claim 1, wherein the polyethylene component (II) is a virgin polyethylene.

6. The polyethylene composition according to claim 1, wherein the polyethylene component (II) is obtained by using a Ziegler-Natta polymerization catalyst.

7. The polyethylene composition according to claim 1, wherein the polyethylene component (II) comprises
from 40 to 50% by weight of a low molecular weight ethylene homopolymer A),
from 25 to 40% by weight of a high molecular weight ethylene copolymer B), and
from 15 to 28% by weight of an ultrahigh molecular weight ethylene copolymer C).

8. The polyethylene composition according to claim 7, wherein the ethylene homopolymer A) has a MIE_{1.2} from 30 to 120 g/10 min., where MIE_{1.2} is the melt flow index at 190 °C with a load of 1.2 kg, determined according to ISO 1133-1 2012-03, the ethylene copolymer B) has a MIP from 2 to 15 g/10 min., and the ethylene copolymer C) has a MIF from 0.1 to 5 g/10 min.

9. The polyethylene composition according to claim 7, wherein the ethylene homopolymer A) has a density equal to or higher than 0.962 g/cm³, the ethylene copolymer B) has a density equal to or higher than 0.955 g/cm³, and the ethylene copolymer C) has a density equal to or higher than 0.950 g/cm³.

10. The polyethylene composition according to claim 1, wherein the polyethylene component (II) has at least one of the following additional features:
a MIE of 0.01 to 1 g/10 min.;
a stress crack resistance, measured by FNCT 6 MPa/50 °C, equal to or higher than 50 h;
a swell ratio from 130% to 180%; or
a Charpy aCN fracture toughness at −30 °C from 5 to 20 kJ/m².

11. The polyethylene composition according to claim 1, having a density from 0.945 to 0.962 g/cm³.

12. The polyethylene composition according to claim 1, having an environmental stress crack resistance, measured by FNCT 6 MPa/50 °C, equal to or higher than 15 h.

13. The polyethylene composition according to claim 1, having a swell ratio from 130% to 180%.

14. A manufactured article comprising the polyethylene composition of claim 1.

15. The manufactured article of claim 14, in form of a blow molded article.
